(19) United States
(12) Patent Application Publication
(10) Pub. No.: US 2012/0196658 A1
(43) Pub. Date: Aug. 2, 2012

(54) Mobile Phone Charging Device with Exchangeable Battery Cell

(75) Inventor: Zhongwei SUN, Singapore (SG)

(73) Assignee: IBATTZ PRIVATE LIMITED, Singapore (SG)

(21) Appl. No.: 13/241,197

(22) Filed: Sep. 22, 2011

(30) Foreign Application Priority Data
Feb. 1, 2011 (CN) 201120034327.2

(51) Int. Cl. H04M 1/00

(52) U.S. Cl. 455/573

(57) ABSTRACT

A mobile phone charging device with exchangeable battery cell including a upper housing, a partition board, a lower housing and a battery cell cover. The device includes a terminal cover; a main board; a button handle; a plug portion, including a circuit board and a plug soldered onto the circuit board. The circuit board has with a pin header through which the plug is electrically and mechanically connected to the female header on the main board; a recharging port, which is attached to the main board, a battery cell and a battery cell cover. The lower housing has a recharging port opening through which the charging plug of an external power adapter is connected.

### TECHNICAL FIELD

The invention relates to a mobile charging device and more particularly relates to mobile charging device with exchangeable battery cell.

### BACKGROUND OF THE INVENTION

Today, mobile phone charger in following types are available in the prior art: AC charger for connecting to a AC power, USB charger for connecting to a USB dock especially to a USB dock on the computer, and car carry charger for connecting to a power dock e.g. the cigarette lighter socket. The three type of chargers are all require fixed power, i.e. the mobile phone can not be charged in a complete wireless state.

### SUMMARY OF THE INVENTION

An objective of the invention is to provide a mobile charging device that is capable of charging a mobile phone any time in any time. A further objective of the invention is the charging device with exchangeable battery cell.

A mobile phone charging device with exchangeable battery cell comprising a upper housing, a partition board, a lower housing and a battery cell cover, the partition board is provided with a groove at one end; the upper housing is provided with clip bump pairs so as to regulate the mobile phone to be charged in a position between the upper housing and the partition board, the device further comprising a terminal cover, which is connected sequentially to the partition board at the grooved end and the lower housing; a main board, which is mounted thereon electronic switch and female header, and is connected to the bottom surface of the grooved end; a button handle, which passes through the terminal cover to abut the electronic switch such that the electronic switch can be activated by an action of the terminal handle; a plug portion, comprising a circuit board and a plug soldered onto the circuit board, the circuit board is provided with a pin header through which the plug is electrically and mechanically connected to the female header on the main board; a recharging port, which is attached to the main board, a battery cell and a battery cell cover, the lower housing is provided with a recharging port opening through which the charging plug of an external power adapter is connected and engaged with the recharging port such that the mobile phone charging device can be recharged after being consumed; and a battery cell, whose connecting leads are connected to the main board, the bottom housing is provided with a battery recess in which clip bumps pairs are provided for positioning the battery cell between the partition board and the bottom cover.

Preferably, the recharging port is a Micro USB port.

Further, the mobile phone charging device 100 can further comprises a PVC panel which is attached to the upper surface of the terminal cover, e.g. by means of double side tape, to seal the button handle and to prevent the button handle from falling off.

The charging device according to one embodiment of the invention is advantageous in that mobile charging of the mobile phone can be realized, in the meantime, with the help of the structure of this mobile phone charging device, the battery cell can be replaced, e.g. by a battery cell with larger capacity, as required freely, the recharging port of the device can be of any type and thus is applicable for the mobile charging of nay any high power consuming mobile electronics, such as large screen smart mobile phones.

### DESCRIPTION OF DRAWINGS

FIG. 1 is an exploded view of the mobile phone charging device with exchangeable battery cell according to one embodiment of the invention;

FIG. 2 is a perspective view of the terminal cover.

FIG. 3 is a perspective view of the plug;

FIG. 4 is a perspective view of the partition board

FIG. 5 is a perspective view of the main board;

FIG. 6 is a perspective view of the bottle cover

### DETAILED DESCRIPTION OF THE PREFERRED EMBODIMENTS

The invention will now be described further in details with reference to the drawing as accompanied.

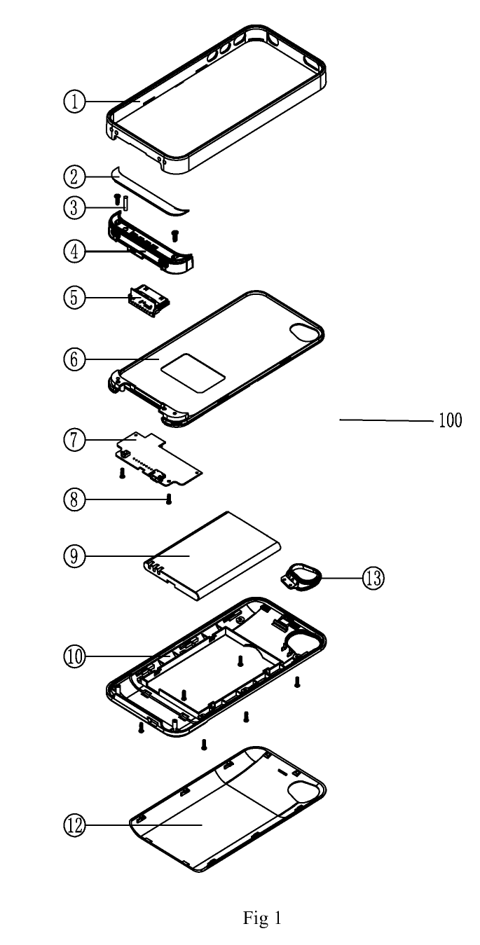

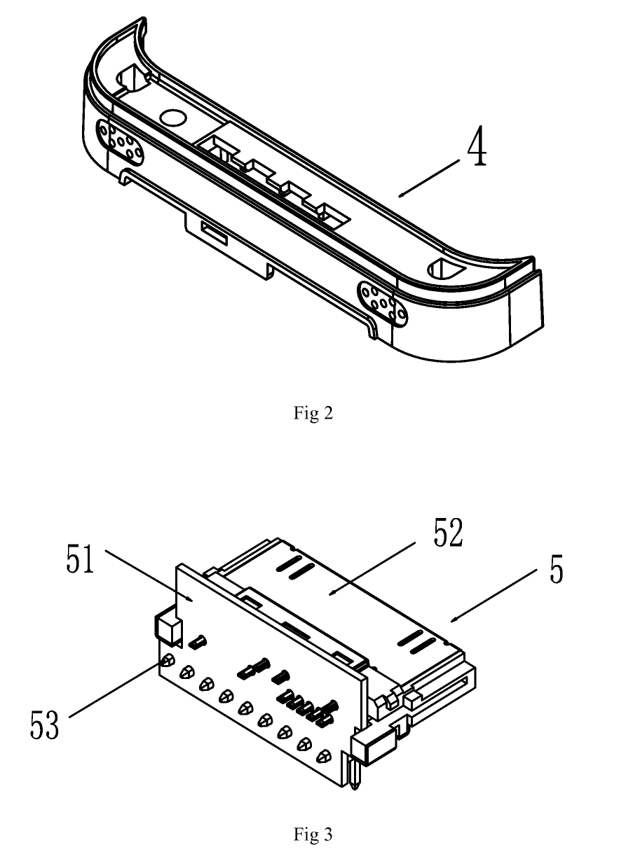

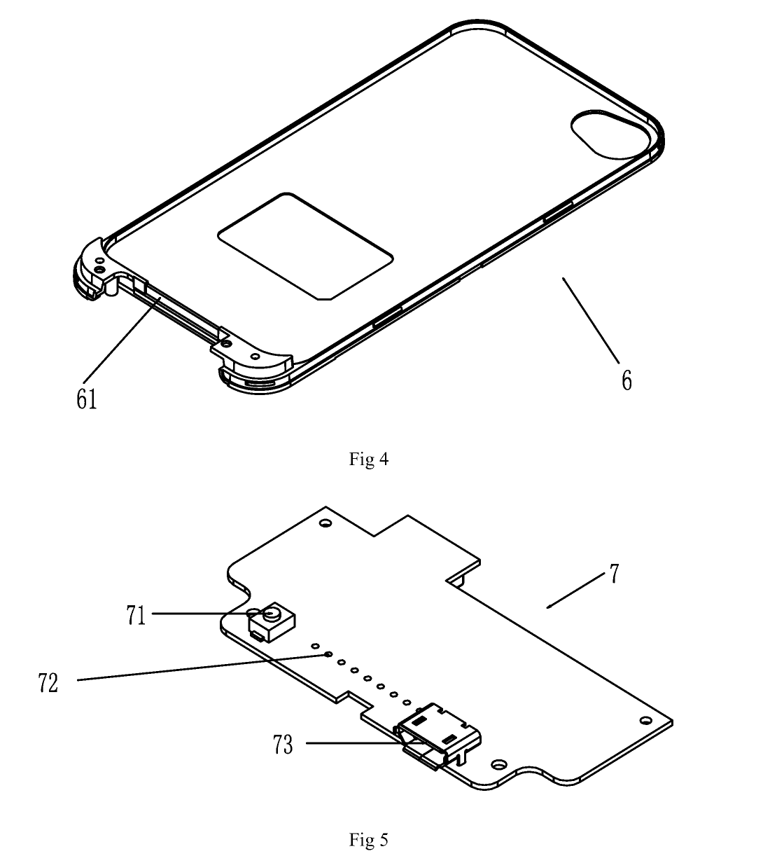

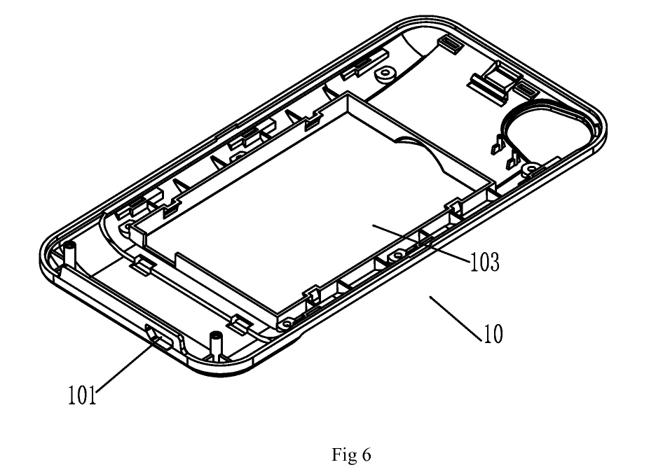

As illustrated in FIGS. 1 to 6, the mobile phone charging device with exchangeable battery cell 100 according to one embodiment of the invention comprises a upper housing 1, a partition board 6 and a lower housing 10, the mobile phone charging device 100 further comprises a terminal cover 4, a button handle 3, a plug portion 5 and a main board 7; the partition board is provided with a groove 61 at one end. The terminal cover 4 is connected sequentially to the partition board at the grooved end 61 and the lower housing 10 by means of e.g. screw. The main board 7, which is mounted thereon electronic switch 71 and female header 72, is also connected to the bottom surface of the grooved end 61. The button handle 3 passes through the terminal cover 4 to abut the electronic switch 71 such that the electronic switch can be activated by an action of the terminal handle. The plug portion 5 is constructed of a circuit board 51 and a plug 52 soldered onto the circuit board 51, the circuit board 51 is provided with a pin header 53 through which the plug 53 is electrically and mechanically connected to the female header 72 on the main board. The plug 52 of the plug portion 5 extends upwardly through the terminal cover 4 to engage with the socket fixed on the partition board 6.

The upper housing is provided with clip bump pairs so as to regulate the mobile phone in a position between the upper housing 1 and the partition board 6.

The mobile phone charging device 100 is further provided with a recharging port 73, and preferably a Micro USB port, attached to the main board 7, a battery cell 9 and a battery cell cover 12. The lower housing 10 is provided with a recharging port opening 101 through which the charging plug of an external power adapter is connected and engaged with the recharging port 73 such that the mobile phone charging device 100 can be recharged after being consumed.

The mobile phone charging device 100 can further comprises a PVC panel 2 which is attached to the upper surface of the terminal cover 4, e.g. by means of double side tape, to seal the button handle and to prevent the button handle from falling off.

In addition, the mobile phone charging device 100 can comprises a camera device 13 which is fixed onto the lower housing e.g. by means of hot melt pole, and is fitted between the lower housing and the partition board.

The mobile phone charging device 100 is activated by pressing the button handle 3 and hold for a predetermined time. The mobile phone to be charged can be laid in the partition board 6 such that the socket on the mobile phone engages with the plug 52 that extend through the terminal cover and in the meantime the mobile phone is hold in the position between the upper housing and the partition board by means of the clip bump pairs. Charging to the mobile phone starts as the plug 52 is electrically connected with the socket on the mobile phone. Once the charging process is finished, the mobile phone can be removed by disassembling the upper housing 1. After the mobile phone is removed the mobile phone charging device 100 can be turned off by pressing the button handle 3 and hold for a predetermined time.

The mobile phone charging device 100 can be recharged by plugging the external power source, e.g. power adapter, or USB cable, to the recharging port 73 through the recharging port opening 101 on the lower housing 10. During recharging of the mobile phone charging device 100, the mobile phone still can be charged by engaging the socket on the mobile phone to the plug on the partition board. As the socket and the plug is engaged with each other, the recharging process is terminated and the charging process to the mobile phone starts.

The invention is applicable to any mobile electronics, especially to mobile phones that have a socket that is functioned as recharging port, preferably, the mobile phone is any generation of iphone®, e.g. iphone 3 or iphone 4.

The power cable of the external power source can have a general type socket, such as a micro USB socket, or a proprietary socket in case the invention is designed for iphone, and thus the recharging port 73 of the device 100 can be a Micro USB socket or any proprietary socket designed for iphone. The device 100 can be recharged by connecting the power cable to the recharging port 73. Alternatively, in case of micro USB socket arrangement, the device 100 can be recharged by a USB cable.

Mobile charging of the mobile phone can be realized by the mobile phone charging device 100 according to this invention; also with the help of the structure of this mobile phone charging device 100, the battery cell 9 can be replaced, e.g. by a battery cell with larger capacity, as required freely, the recharging port of the device can be of any type and thus is applicable for the mobile charging of nay any high power consuming mobile electronics, such as large screen smart mobile phones.

What is claimed is:

1. A mobile phone charging device with exchangeable battery cell comprising a upper housing, a partition board, a lower housing and a battery cell cover, the partition board is provided with a groove at one end; the upper housing is provided with clip bump pairs so as to regulate the mobile phone to be charged in a position between the upper housing and the partition board,
the device further comprises:
a terminal cover, which is connected sequentially to the partition board at the grooved end and the lower housing;
a main board, which is mounted thereon electronic switch and female header, and is connected to the bottom surface of the grooved end;
a button handle, which passes through the terminal cover to abut the electronic switch such that the electronic switch can be activated by an action of the terminal handle;
a plug portion, comprising a circuit board and a plug soldered onto the circuit board, the circuit board is provided with a pin header through which the plug is electrically and mechanically connected to the female header on the main board;
a recharging port, which is attached to the main board, a battery cell and a battery cell cover; the lower housing is provided with a recharging port opening through which the charging plug of an external power adapter is connected and engaged with the recharging port such that the mobile phone charging device can be recharged after being consumed; and
a battery cell, whose connecting leads are connected to the main board, the lower housing is provided with a battery recess in which clip bumps pairs are provided for positioning the battery cell between the partition board and the battery cell cover.

2. The mobile phone charging device with exchangeable battery cell according to claim 1, wherein the recharging port is a Micro USB port.

3. The mobile phone charging device with exchangeable battery cell according to claim 1, wherein the device further comprises a PVC panel which is attached to the upper surface of the terminal cover to seal the button handle and to prevent the button handle from falling off.
